(19) United States
(12) Patent Application Publication
(10) Pub. No.: US 2006/0156353 A1
(43) Pub. Date: Jul. 13, 2006

(54) Remotely-accessible wireless LAN server

(76) Inventor: Elmar Dorner, Karlsruhe (DE)

Correspondence Address: FISH & RICHARDSON, P.C., PO BOX 1022, MINNEAPOLIS, MN, 55440-1022, US

(21) Appl. No.: 11/022,933

(22) Filed: Dec. 28, 2004

(51) Int. Cl. H04N 7/173

(52) U.S. Cl. 725/86

(57) ABSTRACT

A remote-controlled media system is described in which a remote control communicates over a conventional wireless local area network (WLAN) with a remote server. The remote control and remote server configure a network connection over the WLAN for communicating with one another. The remote server receives a remote command from the remote control and associates the remote command with the remote control, an application, and an output device over which the application outputs media data files. The remote server determines a particular output function of the application that is represented by the remote command, and then accesses the application through a command interface of the application to thereby invoke the output feature at the application and the output device.

### TECHNICAL FIELD

This description relates to server applications for wireless networks.

### BACKGROUND

Wireless technologies allow data to be transmitted between devices, without a physical connection or intermediate device. The devices and transmitted data may form a wireless network, in which some or all of the devices on the network are freed from the need for wired connections. Various wireless network protocols have been developed to facilitate, and, in some cases, standardize, communications over the wireless network(s).

Wireless technologies may provide users with convenience and flexibility. For example, to the extent that wireless technologies reduce or eliminate the need for cables between devices, users are freed from decisions regarding, for example, different types of cables that may be used, or different techniques for connecting the cables. Further, problems related to running wiring through walls or other obstructions, or over relatively long distances, may be reduced or eliminated.

Wireless devices and networks thus allow users to enjoy various types and features of computing devices from a distance. For example, some wireless devices are capable of transmitting audio files, over a wireless connection and/or network, to an output device that is capable of playing the audio file (e.g., a stereo or powered speaker), even when the output device is located at a location that is remote from the wireless (transmitting) device.

In such cases, control of the transmitting device may reside at the transmitting device, so that the user is required to be present in order to modify features of the audio transmission. Such a requirement may be inconvenient or impracticable for the user. Moreover, even if some form of remote operation of the transmitting device is possible, such remote operation may be difficult for the user to configure and use, and/or may be proprietary to a particular vendor or manufacturer of the transmitting device and/or output device. In the latter case, then, the user may be limited in terms of the choices and features available through the remote operation. Further, if multiple transmitting devices and/or output devices are used, the user may require multiple techniques and/or devices for implementing the remote operation of each, which, again, may be difficult or impracticable for a particular user.

### SUMMARY

According to one general aspect, a system includes a media application that is operable to output media data files for presentation using an output device, the media application having a command interface for controlling an output feature for the media data files and the output device, and a remote server that is operable to receive a remote command and associate the remote command with the output feature, and further operable to access the command interface of the media application to invoke the output feature, based on the remote command.

Implementations may include one or more of the following features. For example, the remote server may determine the remote command from a command packet received from a remote control over a network connection on a wireless network.

In this case, the remote server may associate the output feature with a selected button on the remote control, based on the command packet and a pre-configured relationship between the remote command and the output feature. The remote server may comprise a protocol component that is operable to receive a broadcast message from the remote control, over the wireless network, and to configure the network connection for receipt of the command packet, based on the broadcast message.

In the latter case, the remote server may include a remote control identifier for identifying the remote control from among a plurality of remote controls configured for communication with the remote server, based on the command packet. The remote server may include an application identifier for identifying the media application from among a plurality of applications, based on the command packet or on a pre-determined association of the remote control with the media application. The remote server may include a device identifier for identifying the output device from among a plurality of output devices, based on the command packet or on a pre-determined association of the remote control with the output device.

The system may include a remote server user interface that is operable to relate the remote command with the output feature. In this case, the media application may include a streaming application for streaming audio or visual files to the output device.

According to another general aspect, a remote command is received over a wireless network, and associated with an output function of an application that outputs media data files to an output device for presentation to a user. A command interface of the application is accessed, and the output function of the application, and thereby the presentation of the media data file over the output device to the user, is invoked through the command interface and based on the remote command.

Implementations may include one or more of the following features. For example, in receiving the remote command, a broadcast message may be received from a remote control, over the wireless network, and a network communication for receiving the remote command may be configured, based on the broadcast message. In this case, associating the remote command with the output function may include identifying the remote control from among a plurality of remote controls, based on the remote command.

In associating the remote command with the output function, a command set may be accessed in which the remote command is associated with the output function. In this case, the command set may be constructed based on configuration information received from the user by way of a user interface.

Also, in associating the remote command with the output function, the remote command may be associated with the application from among a plurality of applications.

According to another general aspect, an apparatus has a storage medium with instructions stored thereon, and the instructions include a first code segment for recognizing a communication from a remote control over a wireless network and configuring a network connection, based on the communication, a second code segment for receiving a command packet from the remote control, over the network connection, the command packet associated with a selected button of the remote control, a third code segment for associating the command packet with an output function of an application, to thereby associate the selected button with the output function, and a fourth code segment for communicating with a command interface of the application to invoke the output function, based on the command packet.

Implementations may include one or more of the following features. For example, the third code segment may include a fifth code segment for identifying the remote control from among a plurality of remote controls, based on the command packet.

The third code segment may include a fifth code segment for identifying the application from among a plurality of applications, based on the command packet or a pre-determined association of the remote control with the application. The third code segment may include a fifth code segment for associating the selected button with the output function, based on configuration received from a user by way of a user interface.

The second code segment may receive the command packet over the network connection by way of a base station that is in communication with the remote control and on the wireless network.

The details of one or more implementations are set forth in the accompanying drawings and the description below. Other features will be apparent from the description and drawings, and from the claims.

### DESCRIPTION OF DRAWINGS

FIG. 1 is a block diagram of a media system that is remotely controlled by commands received via a wireless network.

FIG. 2 is a flowchart illustrating a process in which a user uses a remote control to control media data streams.

FIG. 3 is a timing diagram illustrating an operation of the media system of FIG. 1.

FIG. 4 is a block diagram of a remote server of the media system of FIG. 1.

FIG. 5 is a screenshot of an example of a remote server user interface of the media system of FIG. 1.

FIG. 6 is a flowchart illustrating an operation of the remote server of FIG. 4.

FIG. 7 is a block diagram of an example of a remote control of the media system of FIG. 1.

FIG. 8 is a flowchart illustrating an operation of the remote control of FIG. 7.

FIG. 9 is a block diagram of an implementation of the remote control of FIG. 7.

### DETAILED DESCRIPTION

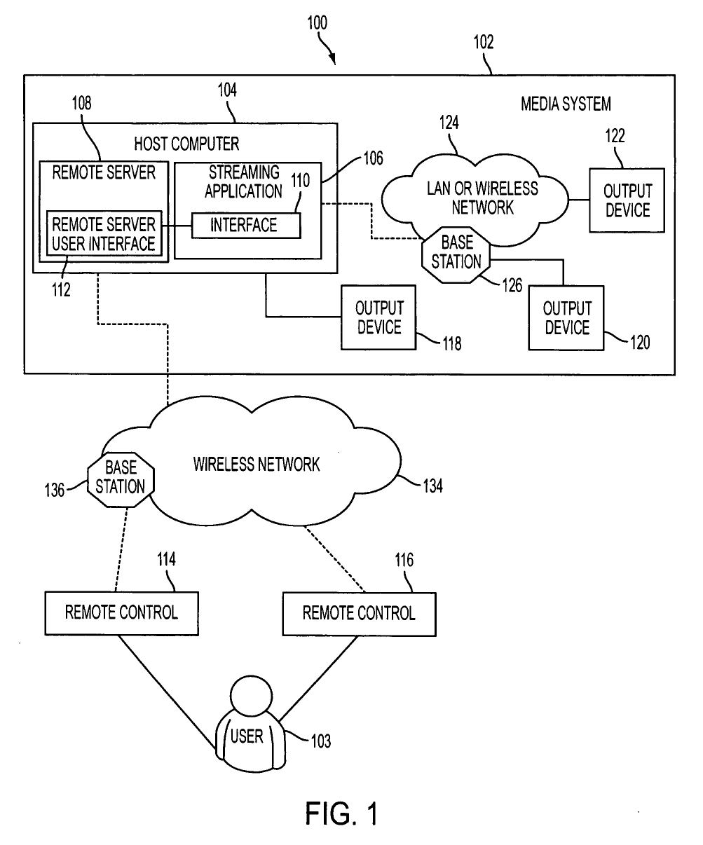

FIG. 1 is a block diagram of a media system 102 that is remotely controlled by commands received via a wireless network. In FIG. 1, the media system 102 generally represents a system for, for example, obtaining, storing, retrieving or accessing audio or visual information. The media system 102 may be operated remotely, to thereby execute commands received via a wireless network. As such, the media system 102 includes various components for performing these and other functions.

For example, the media system 102 includes a host computer 104, which may represent some type of personal computer of a user 103, such as, for example, a general purpose computer, a laptop, a personal digital assistant (PDA), a minicomputer or a much larger mainframe computer. The host computer 104 may be located at a first location, such that the host computer 104 is remote from (or otherwise not easily accessible by) the user 103, who may be at a second location. For example, the host computer 104 may be located in a home office of the user 103, while the user 103 may be in a living room or kitchen (or other room) of the user's home.

The host computer 104 includes a streaming application 106 that accesses media data files and generates corresponding data streams for use and enjoyment by the user 103. Generally, then, the streaming application 106 allows the user 103 to access audio or visual information in an easy and convenient manner. The streaming application 106 may store such audio or visual information, or other media data files, locally, or may access the media data files from a separate application, and/or from a separate computer. The streaming application 106 may include, for example, an audio application that is operable to output songs or other audio files. However, it should be understood that the streaming application 106 may output virtually any type of audio or visual information that may be stored and accessed as a media data file.

The host computer 104 also includes a remote server 108 for receiving remote commands, and executing actions that correspond to the remote commands on the steaming application 106, in order to control the media experience of the user 103. For example, as discussed above, the streaming application 106 may generate and output audio data streams, including songs stored on the host computer 104. As such, the streaming application 106 may have associated commands that are designed to control the outputting of the audio data streams. Such commands may include, for example, commands for selecting and playing a song, or for pausing or stopping a selected song, or for changing a volume of the selected song as it plays.

As referenced above, however, the user 103 may be located remotely from the host computer 104, and, as a result, may not easily be able to access the host computer 104 in order to operate the streaming application 106. Therefore, and as explained in more detail below, the remote server 108 allows the user 103 to access the streaming application 106 indirectly and remotely, and thereby provides for convenience and enjoyment of the user 103 with respect to an operation of the streaming application 106.

In particular, in the example of an audio output, the user 103 may remotely cause the remote server 108 to invoke actions at the streaming application 106 that cause(s) a selected song to play, stop, pause, fast forward, rewind, volume up, or volume down, as the music is played. Thus, the remote server 108 functions as a bridge to enable remote operation of the streaming application 106, so that the streaming application 106 receives and executes the commands received from the user 103.

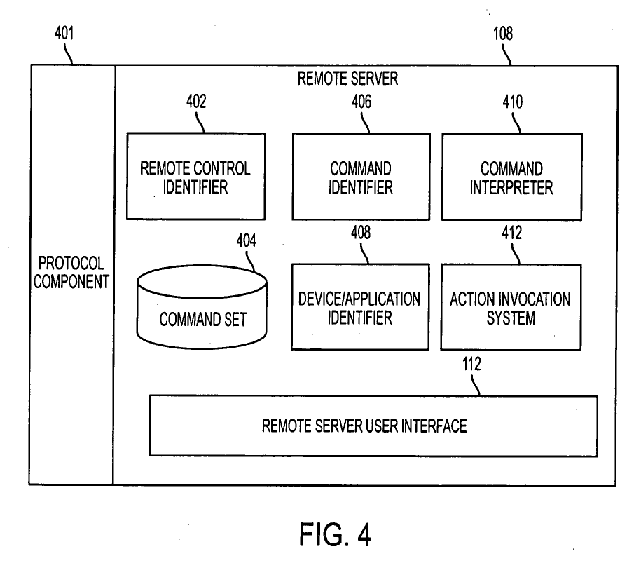

In the example of FIG. 1, the remote server 108 implements a predefined mechanism to interpret remote commands from the user 103, and uses a program, interface, and/or script that is implemented to operate on the streaming application 106 and thereby complete the remote commands. The remote server 108 then executes the program, interface, and/or script to operate the streaming application 106, based on receipt of the remote commands. Details of specific examples of these operations are discussed below, and, in particular, with respect to FIG. 4.

In FIG. 1, the remote server 108 operates on the streaming application 106 through an interface 110. The interface 110 may be offered by the streaming application 106, so that the streaming application 106 thereby allows an outside identity (i.e., a software program, a script or an application that is not part of the streaming application 106) to control and automate actions on the streaming application 106. The interface 110 may be, for example, an application programmable interface (API), and/or a set of scripting commands, and/or a programming language. For example, an AppleScript written for iTunes™, or a Visual Basic script in a Windows™ environment/application, may be used to create play lists, play random tracks, delete selected tracks, loop track section, rewind track and perform many other tasks. By using the API and/or the command sets.( i.e., the interface 110), the remote server 108 is able to implement programs and/or a scripts to perform certain tasks desired by the user 103 (e.g. play, stop, pause, fast forward, rewind, volume up, or volume down) on the streaming application 106.

A remote server user interface 112 allows a user to configure and operate the remote server 108. For example, in the implementation of FIG. 1, the remote server 108 receives remote commands from a remote control 114 and/or 116. In this example, then, the remote server user interface may be used to configure the remote server 108 to manage the communication between the remote control(s) 114 and/or 116 and the streaming application 104. More generally, the remote server user interface 112 allows the user 103 to, for example, start or stop the remote server 108, select a source for remote commands for the remote server 108, interpret one or more remote command(s) into one or more action(s) on the streaming application 106, or select an output device for the streaming application 106.

One source for the remote commands may be, for example, the remote control 114 (or 116). In other examples, the source for the remote commands may be a software program, an online service, or another interface.

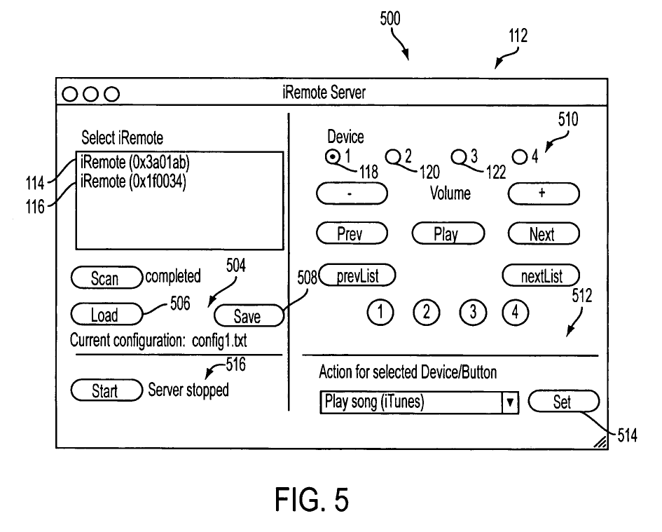

In some implementations, there may be more than one interpretation of a particular command set for operating the remote server 108. In such cases, the user 103 may choose a particular one of the interpretations, using the remote server user interface 112. For example, a particular command received at the remote server 108 may be used to invoke one of a plurality of actions at the streaming application 106, depending on, for example, the source of the remote commands (e.g., whether the remote command is received from the remote control 114, as opposed to the remote control 116). Further details and examples of the remote server user interface 112 are discussed below, and, in particular, with respect to FIG. 5.

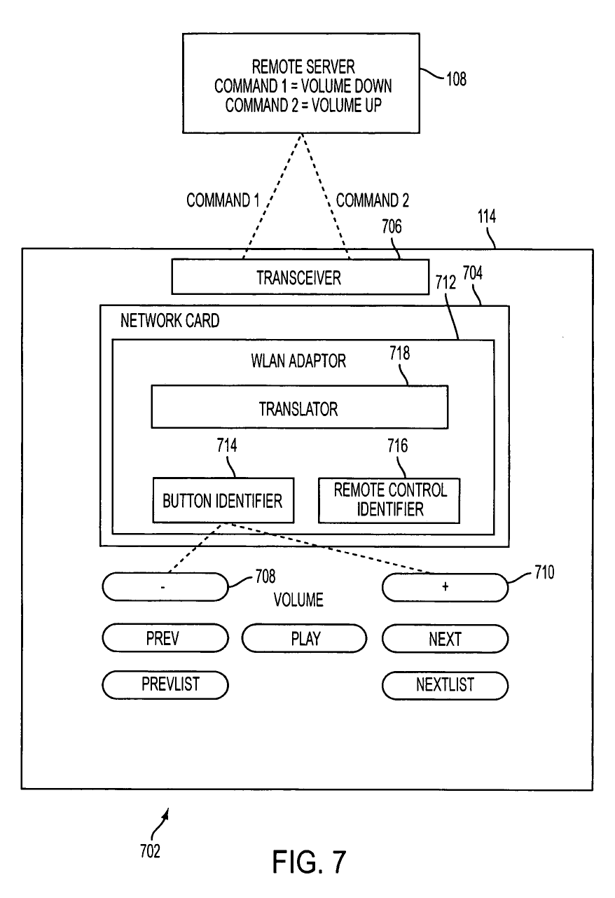

The remote control 114 or 116 may be, for example, a wireless device that remotely operates the streaming application 106 in the host computer 104. The remote control device may be designed for a particular output device, and/or for a particular streaming application, or may be designed to be generic to a number of devices or applications. In some implementations, and as discussed in more detail below with respect to FIGS. 7-9, the remote control 114/116 may be operable to communicate with the remote server 108 using standard Wireless Local Area Network (Wireless LAN, or WLAN) protocols. In such implementations, the remote control 114/116 may be widely applicable to a number of different types of streaming applications, host computers, and/or output devices.

The remote control 114/116 may generally include, for example, standard features of a remote control, e.g. buttons for play, stop, fast forward, rewind, pause and so on. The remote control 114/116 also may include advanced features of the streaming application 106, e.g., playing a random song, reordering the play list, or deleting a song. The remote control 114, 116 may be a single purpose wireless remote control device, or may be part of a multi-purpose wireless device, such as, for example, a personal digital assistant (PDA), a mobile phone, a laptop computer or virtually any wireless device.

In FIG. 1, the media data streams from the streaming application 106 are sent to one or more output device(s) 118, 120 and/or 122. The output device(s) 118, 120 or 122 may generally represent any type of output device(s) that is/are operable to output audio and/or visual information. For example, with respect to audio output devices, the output devices 118, 120, or 122 may represent a stereo with hi-fi speakers, an audio receiver, a headset, a digital media player, powered speakers or virtually any other audio device. With respect to video outputs, the output device(s) 118, 120, or 122 may represent, for example, a monitor, a television set, a mobile phone, a PDA, a projector or virtually any other video device.

Output devices may connect to the host computer 104 in a number of different ways. For example, in FIG. 1, the output device 118 is directly connected to the host computer 104, e.g., through a wired connection. In contrast, the output device 122 is connected to the host computer 104 through a local area network (LAN) or wireless LAN (WLAN) 124. The LAN or WLAN 124 may be, for example, a mix of Ethernet cabling, Wi-Fi (802.11B or 802.11G) wireless networks, IEEE 1394 (FireWire), or phone line networking.

In one implementation, the output device 120 is connected to the host computer 104 through a wireless network, i.e., the network 124, by way of a base station 126. The base station 126 generally represents an access point for a wireless network. The same wireless network 124 and the base station 126 may be used between the host computer 104 and the remote controls 114/116, or a different wireless network/base station, such as, in FIG. 1, a wireless network 134 and base station 136, respectively. Thus, details of specific examples of the wireless network 124 and the base station 126 are discussed further with respect to descriptions of the network 134 and the base station 136, below.

With the remote control 114 and/or 116, the user 103 need only to be within the range of the wireless network 134 to control the media system 102. The wireless remote control 114/116 communicates via the wireless network 134, and, advantageously, does not require a line of sight to operate the host computer 104. Accordingly, the user 103 is able to operate the media system 102 with no physical restriction to be in the vicinity of, nor to be able to see, the host computer 104. As a result, the user 103 may experience freedom and convenience in accessing the media system 102.

For example, the operating range of the wireless remote control 114 or 116 may allow freedom of movement of the user 103 within a wide area. For example, with the (single) base station 136, a range of the wireless network 134 may be about 100-150 feet. In other implementations, this range may be increased through the use of additional base stations. As a result, the user 103 enjoys wireless freedom to control the media system 102 with virtually no distance restrictions, given the extendibility of the wireless network 134.

As mentioned above as an example of the network 124, the wireless network 134 represents the wireless network through which the remote controls (114 and/or 116) communicate with the media system 102. The wireless network 134 may enable two or more computers and/or devices to communicate, using standard network protocols. In one implementation, for example, the network 134 is an ad-hoc, or peer-to-peer wireless network, and includes a number of computers and or devices, each equipped with a wireless networking interface card. Each computer and or device may communicate directly with all of the other wireless enabled computers and/or devices.

For example, the host computer 104 and the remote control 116 may both be Wireless Fidelity (Wi-Fi) certified, and may send and receive data to/from each other anywhere within the range of the wireless network 134. Wi-Fi generally refers to 802.11-based technologies, including, for example, IEEE 802.11a, 802.11b, 802.11g and any future 802.11 technologies that may be developed. “Wi-Fi certified” indicates that the certified computer or device (here, for example, the remote control 114) is configured with a Wi-Fi certified radio transceiver (e.g., a PC Card radio, a USB Wi-Fi adapter or similar device ) and is able to connect anywhere where other compatible Wi-Fi certified products are present.

The remote controls 114/116 may communicate directly with the host computer 104 by supporting a public standard or protocol (sometimes referred to herein as a protocol component), such as, for example, Rendezvous, an open protocol that allows devices to setup network connection(s) automatically, and without requiring substantial (if any) user intervention or configuration. The remote server 108 also may have a corresponding protocol component for communicating with the remote controls 114/116.

Such protocol components generally use industry standard Internet Protocol (IP) protocols to allow devices to find each other automatically, without the need, for example, to enter IP addresses, or to configure Domain Name Service (DNS) servers. The end result is a seamless flow of information to and from remote control devices 114/116 to the host computer 104 (and the remote server 108) over a wireless network 134. Another example of public standard/protocols that may be used for similar functionality is known as Zero Configuration networking, and other examples/protocols also may be used.

In another implementation, the wireless network 134 uses an access point, e.g., the base station 136. The base station 136 acts like a hub, providing connectivity for the wireless computers and/or devices, and may include, for example, Lucent's WaveLAN, Apple's Airport Base Station or WebGear's AviatorPRO. Each base station 136 has a finite range, within which a wireless connection may be maintained between the base station 136 and the client computer and/or devices. The actual distance varies depending upon the environment, but example indoor ranges are 150-300 feet, and example outdoor ranges extend up to 1000 feet or more. As referenced above, the basic operating range of the wireless network 134 may be extended, by, for example, using more than a single base station 136.

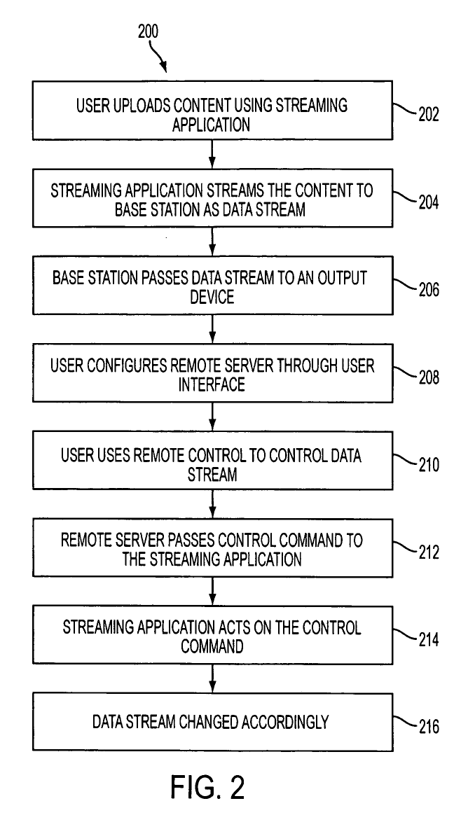

FIG. 2 is a flowchart illustrating a process 200, in which a user uses the remote control 114 (or 116) to control media data streams. In one example, the user 103 operates the media system 102 as illustrated in FIG. 1, using the remote control 114 to operate an audio streaming application 106 that is running on the host computer 104 in a study room of the user 103. The music may be played to the output device 120, which may represent a wireless connected hi-fi speakers, and which may be in a living room of the user 103. (i.e., the hi-fi speakers 120 are connected to the base station 126 in the living room, which is on the same wireless network 124 to which the host computer 104 is connected).

In this example, the user 103 uses the host computer 104 in the study room to upload songs to the audio streaming application 106 (202). The user 103 then selects the living room speakers as the output device 120 for the audio streaming application 106, and begins a playing of these songs on the audio streaming application 106 (as should be understood, and discussed in more detail below, the initiation of the music also may be performed using the remote server 108).

The audio streaming application 106 reads the music data file and generates data streams that can be played on a hi-fi speaker, and then streams the data stream over the wireless network 124 to the base station 126 where the speakers are connected (204). The base station 126 then passes the data stream to the output device 120, i.e., the living room speakers, (206). The data stream then activates the living room speakers 120 to play the music.

Meanwhile, or previously, the user 103 configures the remote server 108 through the user interface 112, thereby establishing a defined relationship between the music remote control 114, the interpretation method for commands from the remote control 114, and the output device of the living room speaker 120 (208). The user 103 thus has the freedom to walk away from the host computer 104 to any other room in the house, or to a space outside of the house, and still retain control over the media system 102 by using the remote control 114.

In one example of FIG. 2, the user 103 uses the remote control 114 to control the data stream by pressing a “stop” button on the remote control 114 to stop the music data stream playing in the living room hi-fi speaker 120. (210). The remote server 108 receives the command from the remote control 114, interprets the command as being a “stop” command, and invokes the control command “stop” at the streaming application 106 by interpreting the “stop” command into a program and/or script that is compatible to “stop” the streaming application 106. In so doing, both the remote server 108 and/or the remote control 114 may use the protocol components referenced above for network recognition, configuration, and communication. The streaming application 106 then acts on the control command “stop” (214) by executing the program and/or script that the remote server 108 generated, as mentioned above. As a result, the music data stream stops (216).

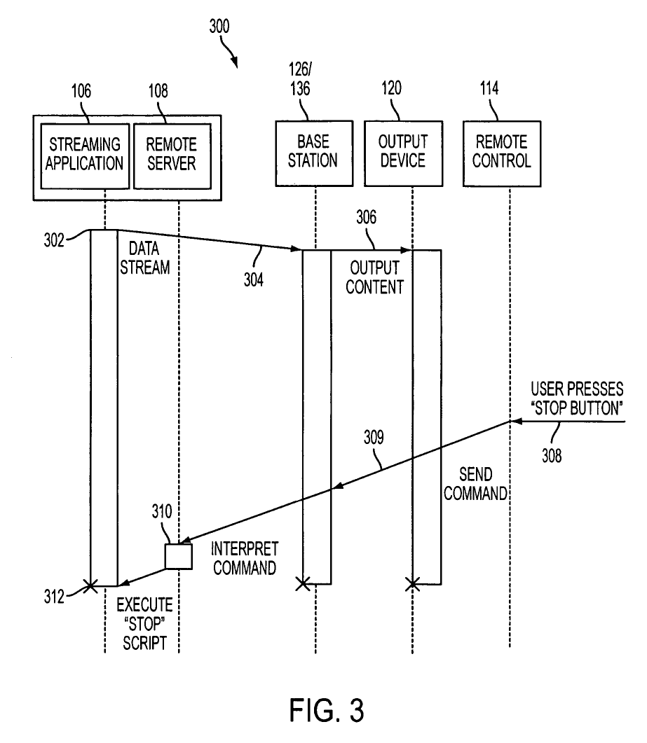

FIG. 3 is a timing diagram illustrating an operation of the remote-controlled media system 102 of FIG. 1. In FIG. 3, the remote control 114 and the output device 120 are on the same wireless network(s) 124 and/or 134, sharing the same base station 126 or 136. The streaming application 106, e.g. the audio application, is playing music by generating the music data streams (302) and sending the music out through the wireless network 124 (304).

The base station 126 receives the data stream, and outputs the data stream to the connected output device 120 (306). As a result, the output device 120 plays the music from the streaming application 106. Then, the user 103 presses a “stop” button on the remote control 114 (308). A command packet is generated at the remote control 114 and transmitted to the base station 136 (309). As described, this command packet may conform to standard WLAN protocols, so that it may easily be transmitted over a standard WLAN network.

The base station 136 then passes the command packet to the remote server 108. The remote server 108 interprets the command packet (310) and generates a piece of code, a program or a command script for the streaming application, i.e., the audio streaming application 106 in this example. The remote server 108 interprets the “stop” command into a “stop” script (310). The streaming application 106 may then execute the “stop” script (312). As a result, the streaming application 106 stops the data stream and the music stops playing in the output device 120.

FIG. 4 is a block diagram an implementation of the remote server 108 of FIG. 1. In FIG. 4, and as generally described above, the remote server 108 receives and interprets remote commands, and invokes or executes the command(s) on the streaming application 106.

The remote command (packets)s may be in the form of a network packet that conforms to standard WLAN technology or technologies. Further, the command packet may be recognized at the remote server 108 by way of a protocol component 401 that communicates with the remote control 114 to recognize a presence of the remote control 114 and to configure a network connection with the remote control 114, without requiring user intervention. That is, the protocol component 401 may, for example, communicate a network address of the remote server 108, so that the remote control 114 may effectively transmit the command packet to the remote server 108.

The command packet may include various types of information that may be useful to the remote server 108 in invoking an action at the streaming application 106. For example, the command packet may provide information about the remote control device from which the remote commands originate (e.g., whether the originating remote control is the remote control 114 or the remote control 116). As another example, the command packets may include information about the command content, e.g., information indicating that a particular button has been pressed at the remote control 114, or information regarding the streaming application 106 (perhaps from among many streaming applications) to which the command packet is targeted.

Thus, in some implementations, the remote server 108 works with a plurality of remote controls, e.g., the remote controls 114, 116 or additional remote controls. A remote control identifier 402 may thus be operable to identify which remote control(s) are present. For example, the remote control identifier 402 may preemptively scan a local environment, and thereby identify all existing remote controls. Additionally, or alternatively, the remote control identifier may parse a remote command packet to determine which remote control transmitted the command.

Further, a command set 404 represents a memory that stores a full list of commands for each remote control with which the remote server 108 works. The command set 404 may also contain a list of programs and/or scripts that execute at least one of the commands from the lists of commands. The command set 404 may store other information related to the operation of the remote server 108, such as, for example, particular streaming application(s) that are associated with the identified remote control.

Thus, by knowing which remote control transmitted which command, as well as which command corresponds to which action at an identified streaming application, a command identifier 406 may be used to identify a command that is included in the remote command packet as being correlated with a particular action at the pertinent streaming application. Moreover, the remote server user interface 112 allows the user 103 to configure all of the above-referenced information. For example, a button on the remote control 114 may cause the remote control 114 to transmit a command to the remote server 108 which is interpreted at the remote server 108 as a “random play” action for the streaming application 106. Then, by using the remote server user interface 112, the same command (i.e., button) from the remote control 114 may be interpreted as a “sequence play” action for the streaming application 106, or even for another streaming application.

Thus, the remote server 108 may manage more than one remote control, along with more than one streaming applications 106. Therefore, the remote server 108 may be considered to serve as a gateway to dispatch received commands from a particular remote control to its corresponding streaming application 106, which in turn controls the corresponding output device(s) 118, 120 or 122. For example, the remote server 108 may identify that a received command from the music remote control 114 is associated with a “play” action for a particular streaming application, and may thus send the command to the particular streaming application to start playing music to the connected output device 120 (e.g., a hi-fi speaker).

As another example, the remote server 108 may identify that a command received from the remote control 116 is associated with a power point application, so that, analogously to the streaming application 106, the remote server 108 will invoke the power point application and thereby initiate a presentation or a slide show on the output device 122, e.g., a connected projector. Thereafter, the remote control 116 may be used to control the slide show, e.g., to move between slides, or even to edit the slides and save the edits.

To implement such functionality, an application/device identifier 408 analyzes the command packet to identify the appropriate application and/or output device(s). In the example of an ad-hoc wireless network, the device identifier 408 may scan and identify all active wireless output devices 118-120 in the wireless net work 124 at a certain moment. The device identifier 408 may also identify the streaming application 106 that communicates with a particular output device 118-122.

That is, for example, some applications may output only to a pre-determined output device(s), so that identification of the output device implicitly identifies the application, or vice-versa. In other cases, it may be possible to select which application is associated with which output device, where such designations may be made using the remote server user interface 112, and/or an interface of the application 106 itself. Thus, in various implementations, the application/device identifier may analyze a received command packet to identify a particular application, a particular device, or both.

If the host computer has only one application and only one output device, then the application/device identifier 408 may not be necessary. Similarly, if only one remote control is used, the remote control identifier 402 may be omitted.

A command interpreter 410 implements a mechanism for generating a command script (a script or a program that would execute a command in the corresponding streaming application 106), as referenced above. The command interpreter 410 may include a pre-defined mechanism to interpret or translate a particular command (obtained by the command identifier 406 by parsing a remote command packet) into a command script/program that performs the corresponding action in the streaming application 106, when executed.

In one implementation, the set of command scripts/programs for performing a set of actions or tasks are previously generated, and saved in (or in associate with) the remote server 108. In such cases, the user 103 may use the remote server user interface 112 to match each of the command scripts/programs with a command from a remote control and an action that is to be invoked at the application 106.

The interpretation mechanism for matching a command set to a set of matching action (by way of the appropriate command scripts/programs) may be saved in the form of a configuration file, such as, for example, a text file or XML file, within the host computer 104. Then, the remote server 108 may have one or more configuration files, so that the user 103 may choose to use one of the configuration files to apply a pre-defined interpretation mechanism for the command interpreter 410.

In such cases, the user 103 may quickly and easily control an operation of a particular remote control with respect to a particular streaming application. For example, if the remote control 114 has ten buttons, the remote server 108 may save ten command scripts that are associated with a first streaming application, and ten command scripts associated with a second streaming application. Then, the user 103 may use the remote server user interface 112 to switch between the two sets of command scripts, in total, so that the user 103 may use the same remote control to control diverse programs, such as, for example, an audio streaming application and a presentation or word-processing application.

In another example, the command interpreter 410 may match a received command with one of a number of command scripts, which may or may not be grouped together according to particular streaming application(s), output devices, or remote controls. In yet another example, the command interpreter 410 may dynamically generate a command script or program, in response to a command received from the remote control 114.

An action invocation system 412 receives the command script from the command interpreter 410, and invokes actions on the streaming application 106 that is outputting to a particular output device, to thereby execute the remote command. For example the action invocation system 412 may execute the command script/script that is generated by the command interpreter 408 on the identified streaming application (as identified by the device identifier 408), and send output data streams to the output device(s) 118, 120 or 122.

It should be understood that FIG. 4 is intended merely as one representation of the remote server 108. Therefore, the remote server 108 may have other functionality, not shown, or may omit some of the elements that are illustrated. Further, specific ones of the elements 402-412 may have overlapping functionality, and/or may execute functionality of multiple ones of the elements 402-412.

FIG. 5 is a screenshot of an example of the remote server user interface 112 of FIG. 1. As referenced above, the remote server user interface 112 allows the user 103 to configure essentially all of the features of the remote server 108 described above, and particularly with respect to FIG. 4. For example, the remote server user interface 112 allows the user 103 to define an identification and/or interpretation mechanism for the remote control 114 (or other originating device) by, for example, matching remote commands with one or more streaming applications, and/or with one or more actions or tasks of the streaming application(s). As another example, the remote server user interface 112 also may be used to choose an output device 118, 120 or 122 for the media system 102, perhaps with respect to a particular remote control (or button thereof) or streaming application.

In the example of FIG. 5, the top left window remote control list 502 shows a list of remote controls 114 or 116 that are operable to interact with the remote server 108 and are configurable by the remote server interface 112. The user 103 may select a remote control on the remote control list 502, and may then use the rest of the user interface 112 to configure commands, applications, and/or output devices for the selected remote control. Of course, the user 103 also may add additional remote controls (or other remote command devices) to the list 502.

The user 103 may click a button “Scan” 504 to obtain a current list of the remote controls 114 or 116 currently active in the wireless network 134. For example, the remote control identifier 402 may be activated for implementing this functionality. The identified list of remote controls is then displayed in the remote controls window 502, for the user 103 to select and configure.

The button “Load” 506 allows the user 103 to choose an existing (remote) command interpretation configuration file from the host computer 104, and to apply that command interpretation configuration file to the selected remote control. That is, as referenced above, if the remote control 114 has ten buttons, there may be a first command interpretation configuration file having ten commands to be associated with the ten buttons, and a second command interpretation configuration file having ten other commands to be associated with the ten buttons. In this way, the user 103 may easily switch between different configuration states, and uses of, the remote control 114.

The user 103 may be prompted with, for example, a pop-up window or user interface that enables the user to browse files in the host computer 104, and to select a (previously or currently configured) command interpretation configuration file. When the user 103 confirms a selection of the command interpretation configuration file (or finishes a configuration/definition thereof), the content of the selected remote command interpretation configuration file is then loaded into the remote server user interface 112.

The button “Save” 508 allows the user 103 to save the current (selected) remote command interpretation configuration into a configuration file. For example, a pop-up window or a user interface that enables the user 103 to enter a file name and file path may be displayed, so that the user 103 may confirm a file name and/or a file path of the command interpretation configuration file. In this way, the current definition of the command interpretation configuration may be saved in the specified file.

The window on the right hand side of FIG. 5 is an interface with buttons 510 and 512, and that resembles the interface of the remote control 114. The device button selection list 510 represents an existing list of the output devices 118, 120 or 122. Thus, a selection of a device from the list indicates the particular one of the output devices 118, 120, or 122 that the selected remote control is controlling. This device selection, in turn, effectively selects the streaming application 106 with which the selected remote control 114.

The buttons 512 below the device selection list 510 are command buttons that trigger actions on the streaming application 106. For example, a “−” and “+” button may decrease and increase the volume respectively, a “play” button may start play a song, a “Prev” button may play a previous song, a “Next” button may play the following song, a “prevList” button may play a previous list of songs, and a “nextList” button may play the following list of songs.

Buttons “1”, “2”, “3”, “4” are additional buttons that the user 103 may use to define additional commands. For example, the user 103 may determine each button's meaning individually, by assigning an action or task to be associated with a particular button. Then, when the user 103 selects a button on the interface 512, the (perhaps) pre-defined task to be executed in the streaming application 106 for the selected button is displayed in a drop down list “Action for selected Device/Button” 514.

The user 103 may change the interpretation of a command from a particular button/remote control by selecting a different action on the drop down list 514. The user 103 may then press a “Set” button 514 to save the new interpretation for the command received from the selected button.

In the bottom left corner, a “Start” button 516 allows the user 103 to start or restart the remote server 108, to thereby respond (or not) to remote controls. The user 103 also may stop the remote server 108, for example, to re-configure a command set for a remote control 114, 116, or to stop the remote controls from controlling the media system 102.

Thus, the remote server user interface 112 allows the user 103 to configure the remote server 108 in a desired fashion. As a result, the user 103 may easily and flexibly make use of one or more remote controls to control a large number of streaming applications and/or output devices.

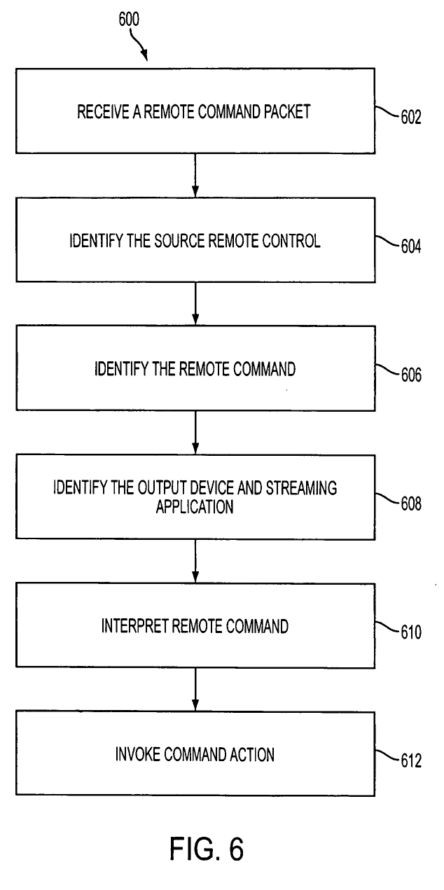

FIG. 6 is a flowchart illustrating an operation of the remote server 108 of FIG. 4. In FIG. 6, the remote server 108 interprets a remote command and invokes an action or task on the streaming application 106. For example, the user 103 may presses a “play” button on the remote control 114, so that the remote control 114 transmits a remote command packet to the remote server 108.

In such a scenario, the remote server 108 receives a remote command packet (602) via the wireless network 134. The remote control identifier 402 parses the remote command packet, and obtains the source of the remote command by, for example, reading a remote control identification (ID) number associated with the remote control 114. (604).

The command identifier 406 then associates the command with a particular button of the remote control 114 to determine the action “play” (606), perhaps by consulting the command set 404. The application/device identifier 408 identifies from the remote command packet the targeted output device 120 and the target streaming application for the command, i.e., the iTunes™ audio streaming application 106 (608). Of course, as referenced above, the application/device identifier 408 may determine a just one of a corresponding application and/or device, or may determine multiple ones, and may do so either before, after, or in conjunction with, the operation of the remote identifier 402 and/or the command identifier 406.

The command interpreter 410 then consults the current command interpretation configuration (i.e. the command interpretation configuration that is (pre-)associated with the identified command/button, remote control, application, and/or output device), and determines a corresponding action or task. The command interpreter 410 then generates or accesses an appropriate command script/program for the identified action or task above (610), and passes it on to the identified streaming application 106. The streaming application 106 then executes the command script/program (612) so that, as an example result, music may be transmitted from the streaming application 106 to the output device 120 (e.g., a hi-fi speaker in the living room).

FIG. 7 is a block diagram of an example of the remote control device 114 of FIG. 1. In FIG. 7, the remote control device 114 includes a key pad 702 that comprises a number of keys/buttons for the user 103 to send commands. The key pad 702 may include hard buttons, or the key pad may be a display/touch screen displaying a number of touch buttons. The user 103 may press the hard button or touch the touch screen button to send a remote command to control the media system 102.

The remote control 114 also includes a network card 704, which may be a piece of hardware and/or software that is instrumental in connecting the remote control 114 to the network 134, and hence enables the remote control 114 to communicate with the host computer 102. The network card 704 may implement one or more network protocols, and may be able to communicate with one or more types of wireless network(s), such as, for example, 802.11a/b/g.

As referenced above, and discussed in more detail below, the network card 704 assembles a remote command network packet, based on a button pressed from the key pad 702. That is, the network card 704 constructs the remote command network packet so as to contain the information required by, or useful to, the remote server 108 in controlling the application 106.

A transceiver 706 may be a radio device that delivers the remote command network packet from the network card 712 to the wireless network 134. The transceiver 706 may be a part of the network card 704, or may be a separate component outside of the network card 702. The transceiver 706 is compatible with the wireless network 134, and, for example, has a compatible transmission frequency. For example, the transceiver 706 may operate on a 2.4 GHz band when working with 802.11b and 802.11g wireless network, or may operate on a 5 GHz band when working with a 802.11a wireless network.

The user 103 may press a button, for example, “−” 708 to, for example, decrease the volume on the speaker 120, or may press a button “+” 710 to, for example, increase the volume of the music played in the media system 102. In one example, where the remote control 114 is designed to work with a Wi-Fi network, a WLAN adaptor(s) 712 on the network card 704 is used to recognize the button pressed, and to generate a remote command packet for the that button. The WLAN adaptor 712 may, for example, be Wi-Fi-certified and interoperable with 802.11 a/b/g wireless network. The WLAN adapter may connect to the Wi-Fi network 134 through a compatible WLAN access point, for example, the base station 136. In addition, the WLAN adaptor 712 may connect directly to an ad hoc wireless network 134, and thereby connect to another Wi-Fi certified WLAN client device.

In some implementations, the WLAN adaptor 712 implements a network protocol, such as, for example, the Zero Conf protocol, or the Rendevous protocol, as mentioned above. In this way, the remote control 114 essentially broadcasts its presence, so as to be detected by the wireless network, and enables communication with other computers/devices on the wireless network. In this way, for example, the host computer 104 on the wireless network 134 may detect a presence of the remote control 114 on the network 134, and the host computer 104 and the remote control 114 may thereby configure a network connection for communication with one another. In other implementations, a different type of adaptor than the WLAN adaptor 712 may be used to work with a different type of wireless network, by, for example, implementing another standard/protocol.

The WLAN adaptor 712 may include a button identifier 714, which would identify an action on the key pad 702, such as, for example, a button or a combination of buttons that are pressed and/or released. The button identifier 714 thus enables generation of a remote command for the identified button or combination of buttons. A remote control identifier 716 may be used in the construction of the remote command packet, in order to include information regarding the identify of the remote control 114 (as opposed, for example, to the remote control 116).

The remote command packet, including information on button(s) pressed and/or an identify of the remote control, as well as other possible information, is formulated by a translator 718. The translator 718 may be the site of the protocol component, referenced above, for setting up the network connection with the remote server 108. The transceiver 706 may then transmit the remote command packet over the network 134 to the remote server 108.

The list of remote commands that the translator 718 generates are recognizable by the remote server 108, and may, for example, be stored in association with the command set 404 in the remote server 108. As discussed above, the remote server 108 may interpret the remote commands into actions on the streaming application 106.

More specifically, for example, the remote command packet, by itself, may not associate any particular action of the streaming application 106 with the pressed button, e.g., the button “−” 708. Rather, the remote command packet may simply indicate that the button 708 on the remote control 114 has been pressed. Then, the duty of extracting this information from the remote command packet, and correlating the information with a command (and thereby an action of the streaming application 106), may fall to the remote server 108 itself.

In other words, the remote server 108 receives the remote command packet as being an essentially generic command, e.g., “command 1,” as shown in FIG. 7. That is, the remote control itself, in this implementation, does not dictate what the result of the pressing of the button “−” 708 may be. Rather, the “command 1” is received at the remote server 108, and the remote server 108, through the actions described above, determines that “command 1” is associated with decreasing a volume of the (particular) streaming application 106. In this way, the user 103 may control all of the actions and abilities of the remote control 114, using the remote server user interface 112.

For example, the user 103 may use the remote server user interface 112 to switch the functions of the buttons 708 and 710, so that the button 708 increases volume, and the button 710 decreases volume. In the described implementation, the remote control 114 would not require any re-configuration or modification (other than perhaps re-labeling of the buttons 708/710, to avoid confusion to the user 103). Rather, pressing the button 708 would have the same result as before the switching of the two functions, i.e., the translator 718 would generate the remote command packet that includes “command 1” as a way of identifying the button 708 and the remote control 114. Then, the remote server 108 would determine that “command 1” is now associated with increasing, rather than decreasing, volume. Such an implementation may minimize the functionality and complexity of the remote control 114, while allowing a great deal of flexibility in the use of the remote control 114, through the remote server 108.

In other implementations, there may be partial or complete association of the remote command packet with a particular command, remote server, streaming application (or action thereof), and/or output device, within, for example, the translator 718. For example, if the remote control 114 is always intended to be particular to the streaming application 106, then an identifier associate with the streaming application 106 may be included within the remote command packet by the translator 718. Similarly, as another example, if the button 708 is always associated with a “volume down” function, but possibly for multiple streaming applications, then an associated with a “volume down” action may be included in the remote command packet by the translator 718.

In such examples, the configuration of the translator 718 may be performed through the remote server 108, or may otherwise be performed remotely. Otherwise, the translator 718 may be configured at the remote control 114. For example, the remote control 114 may have a display/touch screen, as referenced above, with which the user 103 may configure the translator 718 by designating information regarding each button on the remote control. Such configuration information may be stored locally to the remote control, or may be stored and/or accessed remotely by the remote control, over the wireless network 134.

As should be understood, the translator 718 translates a particular remote command packet into (or generates the remote command packet as) a network packet for that is compliant with the wireless network 134. For example, in a Wi-Fi network, the translator 718 may generate data packets that comply with IEEE 802.11a/b/g standards, and that therefore interoperates with any 802.11a/b/g compliant devices.

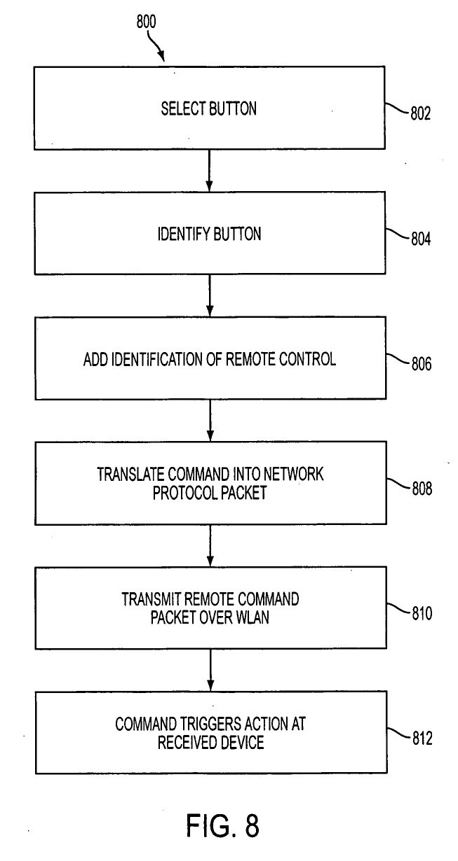

FIG. 8 is a flow chart of a process 800, in which the remote control device 114 sends commands to control other portions of the media system 102. The process 800 starts when the user 103 select a button (802), for example, “+” 710 on the key pad 702, by pressing on a hard button or touching a touch screen button, to increase the volume of the music played in the media system 102.

The button identifier 702, as shown in FIG. 7, identifies that the button 710 is pressed, and associates the button-press event with a command, for example, “command 1,” or, less generically, “volume+” (804). The remote control identifier 716 provides an identifier for the remote control 114 (806), and then the translator 718 combines the button-press information with the remote control identifier to obtain a remote command packet that complies with a selected or determined network protocol.

Thus, the network protocol packet includes at least the button-press information and (unless only one remote control is being used) the remote control identification information. The translator 718, as discussed above, may determine other information to be included within the remote command packet, such as, for example, the association of the button-oress information with the command “volume+,” and/or an identification of the streaming application 106.

The translator 718 generates the remote command packet in a format that confirms to a network protocol implemented by the wireless network 134, such as, for example, the Wi-Fi wireless network. The network protocol packet is then transmitted by, for example, the transceiver 706 over the wireless network 134 (810). The host computer 104 receives the remote command packet that conforms to the network protocol and that includes the button-press information and remote control identifier, and passes it on to the remote server 108.

The remote server 108 then parses the remote command (network protocol) packet, and triggers action on the streaming application 106 so as, for example, to increase the volume of the output device 120 (814). If the remote command packet contains information relating to a nature of the action required by the streaming device, then the role of the remote server 108 may be reduced or eliminated. For example, if the remote command packet includes all the information necessary to invoke a desired action at the streaming application 106, then the remote server 108 may simply interact with the interface 110 of the streaming application 106 to invoke the action, without performing any specific decision-making functionalities. In other implementations, it may be possible for the remote control to interact directly with the streaming application 106 (i.e., with the interface 110) to invoke a desired action.

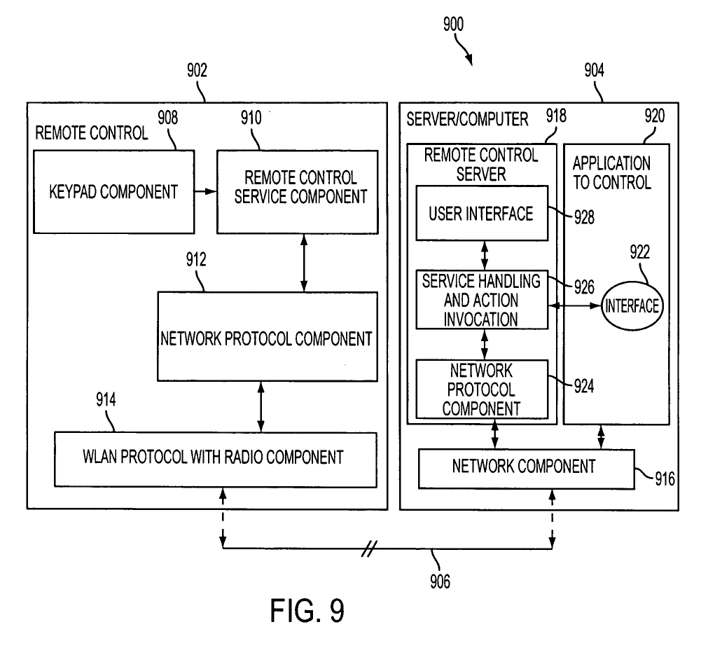

FIG. 9 is a block diagram of an example of the wireless remote control of FIG. 7, in the context of a wireless, remote-controlled system 900. The wireless remote controlled system 900 includes a remote control 902, which operates a server/computer 904 through a wireless network 906.

The remote control 902 includes a key pad component 908, through which the user 103 inputs commands, that is similar in concept to the key pad 702 in FIG. 7. In some implementations, the keypad 902 may operate similarly to conventional, infra-red (line-of-site) remote controls, in terms of the types of buttons and the techniques used for identifying selection of the buttons by the user (e.g., physical buttons or buttons that are graphically presented on a touch-screen). For example, in some implementations, a body of a conventional remote control may be used in conjunction with the various (network) components described below, so as to maximize an efficiency of manufacture of such remote controls by using conventional manufacturing techniques wherever feasible.

A remote control service component 910 identifies the user inputs from the key pad 908 and translates the user inputs, e.g. button-press information, into a remote command. Then, in the example of FIG. 9, a Rendezvous (or Zero-Config or UPnP) protocol component 912 implements a public protocol that allows the remote control 902 to communicate with a wireless network 906 automatically, without any user configuration to establish the connection with the network 906.

Thus, the protocol component 912 is able to identify the remote control 902 to the wireless network 134. The remote control 902 also includes a WLAN protocol with radio component 914. By applying the WLAN protocol, a network packet is able to communicate with another WLAN device/computer. The radio component transmits the remote command packet to the wireless network 906. Thus, in some implementations, the described functionality of the remote control 902 may be thought of as the remote control 902 offering its ability to send data (i.e., the command packet for each button(s) pressed) as a WLAN service to the network 906, and, thereby, to the server/computer 904. To the extent that the user 103 has already established a WLAN, the remote control 902 may thus begin communications therewith, quickly and easily.

In the Server/Computer 904, a network component 916 communicates with one or more networks that the computer/sever belongs to, such as, for example, LAN Ethernet cabling, Wi-Fi (802.11B or 802.11G) wireless networks, IEEE 1394 (FireWire), or phone line networking. The network component 916 may be a common interface that many applications in the server/computer 904 share in order to connect to outside networks.

For example, a remote control server 918 communicates with the remote control 902 through network component 916, while an application 920 communicates with the output devices 118-122 through the network component 916. The network component 916 may implement multiple network protocols, and may serve as a gateway to identify communications from multiple networks, and dispatch the communications to corresponding applications in the server/computer 904. For example, the network component 916 may pass the remote command network packet to the remote control server application 918, while passing data streams from the application 920 to the output device 120.

The remote control server 918 may operate the application 920 through an interface 922, e.g. a scripting API, as discussed above in the context of the interface 110 in FIG. 1. In this way, a remote command from the remote control server 918 may be executed in the application 920, through the interface 922.

As discussed, the remote command may be received from the network component 916 in the form of a remote command network packet. A protocol component 924 implemented in the remote control server 918, which is analogous to and/or interoperable with the protocol component 912 (e.g., Rendezvous or Zero Config protocol component(s)) may automatically obtain the remote command from the remote command network packet and identify the source remote control 902.

The remote control server 918 may then, for example, initiate a service to handle the obtained incoming remote command. A service handling and action invocation component 926 may start a service to run a process, for example, the process 600, to interpret a remote command and invoke action on the application 920.

The remote control server 918 also may include a GUI 928 to allow the user 103 to configure the remote control server, such as to, for example, define actions for each remote command from a remote control 902. An example of the GUI 928 is illustrated in FIG. 5.

As described above, a remote-controlled media system allows users to enjoy applications on a host computer, even when not in the vicinity of the host computer. The remote operation may occur by way of conventional WLAN technologies, so that remote controls may be applicable across a range of applications. Moreover, the remote media system is easily configured and implemented by the user.

A number of implementations have been described. Nevertheless, it will be understood that various modifications may be made. For example, various functions of the remote server may be implemented at the remote control(s), and vice versa. Accordingly, other implementations are within the scope of the following claims.

What is claimed is:

1. A system comprising:
a media application that is operable to output media data files for presentation using an output device, the media application having a command interface for controlling an output feature for the media data files and the output device; and
a remote server that is operable to receive a remote command and associate the remote command with the output feature, and further operable to access the command interface of the media application to invoke the output feature, based on the remote command.

2. The system of claim 1 wherein the remote server determines the remote command from a command packet received from a remote control over a network connection on a wireless network.

3. The system of claim 2 wherein the remote server associates the output feature with a selected button on the remote control, based on the command packet and a pre-configured relationship between the remote command and the output feature.

4. The system of claim 2 wherein the remote server comprises a protocol component that is operable to receive a broadcast message from the remote control, over the wireless network, and to configure the network connection for receipt of the command packet, based on the broadcast message.

5. The system of claim 4 wherein the remote server comprises a remote control identifier for identifying the remote control from among a plurality of remote controls configured for communication with the remote server, based on the command packet.

6. The system of claim 4 wherein the remote server comprises an application identifier for identifying the media application from among a plurality of applications, based on the command packet or on a pre-determined association of the remote control with the media application.

7. The system of claim 4 wherein the remote server comprises a device identifier for identifying the output device from among a plurality of output devices, based on the command packet or on a pre-determined association of the remote control with the output device.

8. The system of claim 1 comprising a remote server user interface that is operable to relate the remote command with the output feature.

9. The system of claim 8 wherein the media application includes a streaming application for streaming audio or visual files to the output device.

10. A method comprising:
receiving a remote command over a wireless network;
associating the remote command with an output function of an application that outputs media data files to an output device for presentation to a user;
accessing a command interface of the application; and
invoking the output function of the application, and thereby the presentation of the media data file over the output device to the user, through the command interface and based on the remote command.

11. The method of claim 10 wherein receiving the remote command comprises:
receiving a broadcast message from a remote control, over the wireless network; and
configuring a network communication for receiving the remote command, based on the broadcast message.

12. The method of claim 11 wherein associating the remote command with the output function comprises identifying the remote control from among a plurality of remote controls, based on the remote command.

13. The method of claim 10 wherein associating the remote command with the output function comprises accessing a command set in which the remote command is associated with the output function.

14. The method of claim 13 comprising constructing the command set based on configuration information received from the user by way of a user interface.

15. The method of claim 10 wherein associating the remote command with the output function comprises associating the remote command with the application from among a plurality of applications.

16. An apparatus comprising a storage medium having instructions stored thereon, the instructions including:
a first code segment for recognizing a communication from a remote control over a wireless network and configuring a network connection, based on the communication;
a second code segment for receiving a command packet from the remote control, over the network connection, the command packet associated with a selected button of the remote control;
a third code segment for associating the command packet with an output function of an application, to thereby associate the selected button with the output function; and
a fourth code segment for communicating with a command interface of the application to invoke the output function, based on the command packet.

17. The apparatus of claim 16 wherein the third code segment includes a fifth code segment for identifying the remote control from among a plurality of remote controls, based on the command packet.

18. The apparatus of claim 16 wherein the third code segment includes a fifth code segment for identifying the application from among a plurality of applications, based on the command packet or a predetermined association of the remote control with the application.

19. The apparatus of claim 16 wherein the third code segment includes a fifth code segment for associating the selected button with the output function, based on configuration received from a user by way of a user interface.

20. The apparatus of claim 16 wherein the second code segment receives the command packet over the network connection by way of a base station that is in communication with the remote control and on the wireless network.
